(19) United States
(12) Patent Application Publication
(10) Pub. No.: US 2012/0013646 A1
(43) Pub. Date: Jan. 19, 2012

(54) IMAGE DISPLAY DEVICE AND IMAGE DISPLAY DEVICE DRIVE METHOD

(75) Inventors: Hideki Ichioka, Osaka (JP); Toshiharu Kusumoto, Osaka (JP)

(73) Assignee: Sharp Kabushiki Kaisha, Osaka-shi, Osaka (JP)

(21) Appl. No.: 12/737,760

(22) PCT Filed: May 21, 2009
(86) PCT No.: PCT/JP09/59374

§ 371 Date: Feb. 14, 2011

(30) Foreign Application Priority Data
Aug. 26, 2008 (JP) 2008-217447

(51) Int. Cl. G09G 5/10; G09G 5/00

(52) U.S. Cl. 345/690; 345/204

(57) ABSTRACT

A television receiver according to at least one embodiment of the present invention includes a display section capable of displaying a TV image and a harmonious image being in harmony with a wall surface against which the image display device is provided.

### TECHNICAL FIELD

The present invention relates to an image display device having a display mode in which an image in conformity with an environment in which the image display device is installed is displayed, and a drive method for driving such an image display device.

### BACKGROUND ART

For home electronics, it has been a demand for products whose presence is not so uncomfortable when the products are not in use for their primary functions. Among such home electronics, image display devices such as television receivers have been getting larger in size, whereby their presence is getting more uncomfortable. Therefore, the aforementioned demand is getting higher for image display devices.

Their display section occupies a majority of an outer appearance of these image display devices, thereby being eye-catching. Thus, it is desirable to improve the display section in this regard. In the following, this problem is explained in more details, referring to a television receiver (image display device) having a display section constituted by a display screen of a liquid crystal display element.

A television receiver employing a liquid crystal display element is installed on a wall in some cases for its light weight and its thin thickness. Moreover, the liquid crystal display element shows a totally black display screen when it is turned off.

Thus, when the television receiver on the wall is off, this means that there is a black article on the wall. The “black article” on the wall is not favorable in terms of interior aesthetic. Especially, recent development of large-size television receivers leads to unfavorable outcome in terms of interior aesthetic.

To solve this, for example, it has been proposed that a still image is displayed while the television receiver is not in use for its primary function of displaying image data such as broadcast, video, etc.

One example of such a technique relating to the display of the still image is displayed in Patent Literature 1 in which still image display operation and moving image display operation are carried out with different brightness. More specifically, the moving image display operation for video image etc. is carried out with a high brightness and the still image display operation for still image of personal computers etc. is carried out with a low brightness.

### CITATION LIST

### Patent Literature

Patent Literature 1

Japanese Utility Model Application Publication, Jitsukaihei, No. 6-47989 (Publication Date: Jun. 28, 1994)

### SUMMARY OF INVENTION

However, the technique disclosed in Patent Literature 1 etc. is developed mainly for reducing electric power consumption, or for alleviating eye fatigue. Thus, television receivers may be further improved for displaying an image that does not deteriorate interior aesthetic, for example, while they are not in user for their primary function.

Moreover, recently, there is a television receiver having a function of displaying a television image only on part of its display section (so-called partial driving). Such a television receiver has another problem that a viewer would feel a sense of discomfort as to the other part of the display section, which other part is not in use for displaying the television image.

The present invention was made in view of aforementioned problem, and an object of the present invention is to provide an image display device and a drive method thereof, each of which can improve interior aesthetic by displaying an image harmonious with an environment in which the image display device is installed.

In order to attain the object, an image display device according to the present invention is an image display device including: a display section for displaying an image; image capturing means for obtaining a background image of a background against which the image display device is provided; the display section displaying a harmonious image according to the background image obtained by the image capturing means, the harmonious image being in harmony with the background. With this arrangement, the display section displays the harmonious image being in harmony with the background. Thereby, the display section and the background against which the image display device is installed can be in harmony with each other. As a result, the image display device can be less eye-catching in the environment in which the image display device is installed.

Here, the “harmonious image” is an image that can cause the image display device to be less eye-catching against the background, compared with the case where the display device of the image display device is fully turned off.

In the image display device according to the present invention, it is preferable that the harmonious image is hued similarly to the background, and it is further preferable that the harmonious image is the background image.

In the image display device according to the present invention, it may be so arranged that the image display device is a television receiver; and the display section displays the harmonious image when the display section does not display a television image.

In the image display device according to the present invention, it may be so arranged that the display section displays an image smaller than a size of the display section, and displays the harmonious image in a region in which the image is not displayed.

In the image display device according to the present invention, it may be so arranged that the region in which the harmonious image is displayed has a surface brightness of 50 cd/m² or less.

A method according to the present invention is a method of driving an image display device having a display section for displaying an image, the method comprising: obtaining a background image of a background against which the image display device is provided; and the display section displaying a harmonious image according to the background image thus obtained, the harmonious image being in harmony with the background. According to the method, it is possible to cause the image display device to be less eye-catching in the environment in which the image display device is installed.

In the method according to the present invention, it may be so arranged that the image display device is a television receiver; and the display section displays the harmonious image when the display section does not display a television image.

In the method according to the present invention, it may be so arranged that the display section displays an image smaller than a size of the display section, and displays the harmonious image in a region in which the image is not displayed.

According to the image display device or the method according to the present invention, as described above, the display section displays the harmonious image being in harmony with the background. Thereby, the display section and the background against which the image display device is installed can be in harmony with each other. As a result, the image display device can be less eye-catching in the environment in which the image display device is installed.

For a fuller understanding of the nature and advantages of the invention, reference should be made to the ensuing detailed description taken in conjunction with the accompanying drawings.

### BRIEF DESCRIPTION OF DRAWINGS

FIG. 1 is an explanatory view of one example of a television receiver illustrated in FIG. 2, illustrating one embodiment of the present invention.

FIG. 2 is a schematic block diagram illustrating a configuration of a television receiver (image display device), illustrating one embodiment of the present invention.

FIG. 3 is a flow chart illustrating one example of a flow of display operation of a harmonious image, illustrating one embodiment of the present invention.

FIG. 4 is a flow chart illustrating another example of a flow of display operation of the harmonious image, illustrating one embodiment of the present invention.

FIG. 5 is a flow chart illustrating still another example of a flow of display operation of the harmonious image, illustrating one embodiment of the present invention.

### DESCRIPTION OF EMBODIMENTS

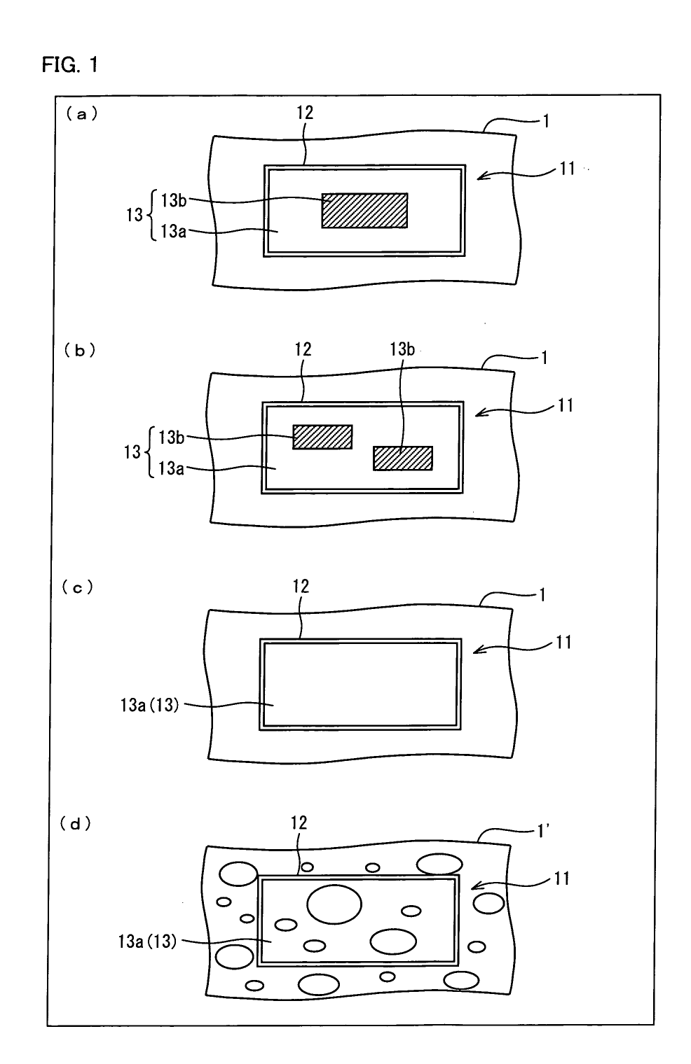

In the following, one embodiment of the present invention is described referring to FIGS. 1 to 5.

(Example of Configuration of Image Display Device)

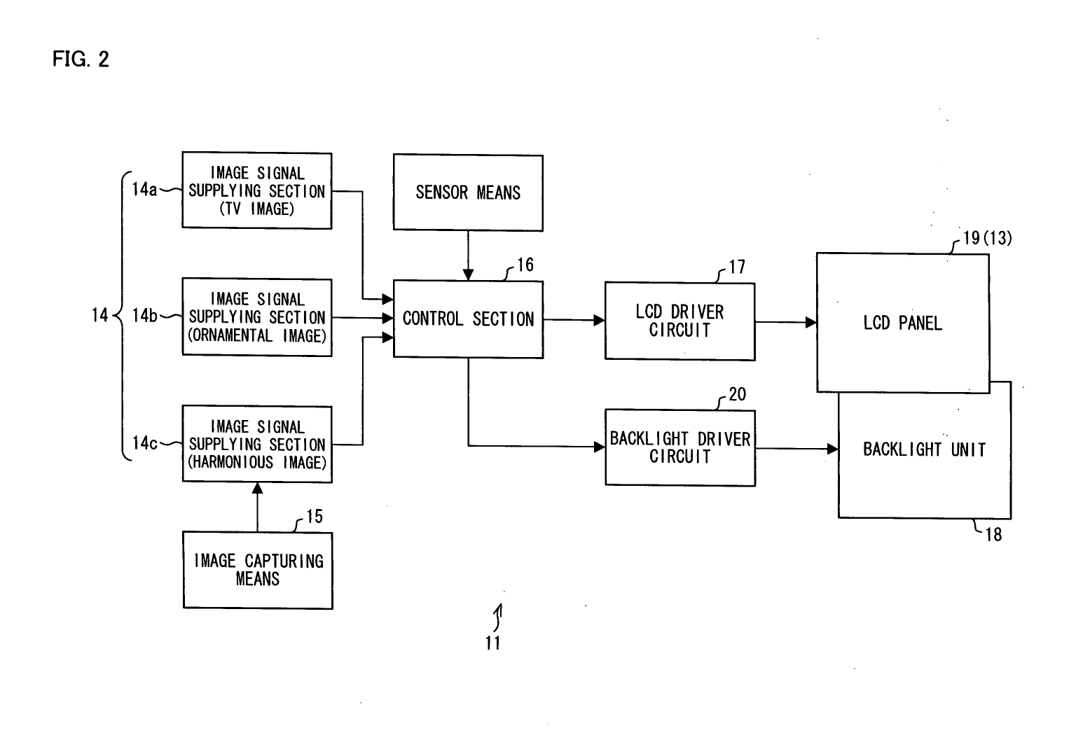

FIG. 2 is a schematic block diagram illustrating a configuration of a television receiver (image display device) 11 as one example of an image display device according to the present invention. As illustrated in FIG. 2, the television receiver 11 includes an LCD (Liquid Crystal Display) panel (display section) 19, a backlight unit 18, an LCD driving circuit 17, a backlight driver circuit 20, a control section 16, an image capturing means 15, an image signal supplying section 14, and a tuner (not illustrated). Here, the LCD driver circuit 17 includes a signal line driver circuit and a scanning line driver circuit.

The image signal supplying section 14 includes an image signal supplying sections 14a, 14b, and 14c. The image signal supplying section 14a is configured to supply to the control section 16 an image signal for television image (TV image (moving image). The image signal supplying section 14b is configured to supply to the control section 16 an image signal for an ornamental image such as a certain fine art, photograph, or the like. The image signal supplying section 14c is configured to supply to the control section 16 an image signal for a harmonious image later described. Moreover, the image signal supplying section 14c is connected with the image capturing means 15 such as a digital camera or the like, and is configured to receive digital data (harmonious image) of a background, which digital data is obtained (captured) by the image capturing means. Further, the image signal supplying section 14c is configured to store the digital data. That is, the image signal supplying section 14c has a function of a memory (storing means) for storing the digital data (harmonious image) of the background against which the television receiver 11 is installed.

The control section 16 includes an LCD panel control section (controller) and a backlight control section. In accordance with a display mode of the television receiver 11, the control section 16 controls the LCD driver circuit 17 and the backlight driver circuit 20, so as to control display of the LCD panel 19. For example, when the television receiver 11 is in a TV image display mode for displaying a television image, the control section 16 controls the LCD driver circuit 17 in accordance with the image signal supplied from the image signal supplying section 14a, and controls the backlight unit 18 by controlling the backlight driver circuit 20.

When the television receiver 11 is in an ornamental image display mode for displaying the ornamental image such as fine art, photograph, etc., the control section 16 controls the LCD driver circuit 17 in accordance with the image signal supplied from the image signal supplying section 14b, and controls the backlight unit 18 by controlling the backlight driver circuit 20.

When the television receiver 11 is in a harmonious image display mode for displaying the harmonious image harmonious with the background, the control section 16 controls the LCD driver circuit 17 in accordance with the image signal supplied from the image signal supplying section 14c, and controls the backlight unit 18 by controlling the backlight driver circuit 20.

The television receiver 11 may display the TV image or the ornamental image on part of the LCD panel 19 and display the harmonious image on the other part of the LCD panel 19, like so-called partial driving. Thus, the harmonious image display mode and one of the TV image display mode and the ornamental image display mode may be carried out at the same time.

(Example of Display Mode of Image Display Device)

In the following, one example of embodiment of the image display of the television receiver 11 illustrated in FIG. 2 is described in more details. (a) to (d) of FIG. 1 are explanatory views of one example of display mode of the television receiver 11 illustrated in FIG. 2. (a) of FIG. 1 illustrates one example of the TV image displaying mode or the ornamental image display mode. (b) of FIG. 1 illustrates another example of the TV image displaying mode or the ornamental image display mode. (c) of FIG. 1 illustrates one example of the harmonious image display mode. (d) of FIG. 1 illustrates another example of the harmonious image display mode.

The television receiver 11 includes a display section (corresponding to the LCD panel 19) 13 for displaying an image thereon, and an outer frame 12 for externally framing the display section 13. The display section 13 is configured to display the moving image such as TV image, and the harmonious image harmonious with the background (wall surface 1) against with the image display device (television receiver 11) is installed.

Here, the “harmonious image” is an image that can cause the image display device to be less eye-catching in the background by blending the display section 13 into the background, compared with the case where the display device 13 of the television receiver 11 is fully turned off (powered off). More specifically, the harmonious image may be, but not limited to, 1) an image (preferably still image) that is similarly hued with a color(s) of the wall surface 1 as the background, 2) an image (preferably still image) that is in the same color as the wall surface 1, 3) an image of the same pattern as the wall surface on the premises of 1) or 2), or 4) an image of the wall surface 1 per se. Among the example listed above, 2) is preferable, 3) is more preferable, and 4) is further preferable, for the sake of blending the display section into the background, thereby causing the image display device to be less eye-catching in the environment. Especially, 3) or 4) is preferable in case where the wall surface 1 as the background has a pattern. By adopting 3) or 4), the display section can be harmonious with the background in terms of not only color but also pattern.

For selecting a “color harmonious with the background” like the case of 1) or 2), a known method in the field of science of color may be adopted as appropriate. One non-limiting example is such that a color(s) belonging to same hue category with the color(s) of the background is selected as the color(s) of the harmonious image (in this case, the harmonious image is similarly hued with the background). It is more preferable that a color(s) identical with the color(s) of the background is selected as the color(s) of the harmonious image. For better blending the harmonious image into the background, it is preferable that a hue circle is formed with 6 or more hues, and it is more preferable that the hue circle is formed with 12 or more hues. Moreover, the image display device may be configured to store a hue correlation table, so that a color(s) suitable for the harmonious image can be automatically selected. In case the hue is achromatic color such as white, black, gray, etc., something corresponding to the hue circle, for example, may be formed by arranging colors with gradually different brightness in circle, so that a color(s) suitable for the harmonious image can be selected.

Moreover, “the background against which the image display device is installed” is a “background” of the display section 13 viewed from its front. In case the television receiver 11 is a wall-hung thin television as illustrated in (a) to (d) of FIG. 1, wall surfaces 1 and 1′ against which the television receiver 11 is installed are the background. If not, something behind the display section 13 is the background.

In the following, one example of the display mode of the television receiver 11 is explained in more details. The television receiver 11 in this example is a wall-hung television receiver and installed on a wall surface 1 in white without pattern. If the television receiver 11 is fully turned off (not illustrated), the display section 13 looks like a black flat surface, which is eye-catching against the white wall surface 1.

The television receiver 11 is, as illustrated in (a) of FIG. 1, used for displaying the TV image or the ornamental image on a part 13b of the display section 13. The part 13b is located in a central portion of the display section 13. That is, this example describes a configuration where an image smaller than a size of the display section 13. In this case, an image of the wall surface 1 is displayed as the harmonious image on another part 13a of the display section 13. The another part 13a surrounds the part 13b in this example. That is, the display section 13 has the part 13b for displaying the TV image or the ornamental image, and the another part 13a for displaying the harmonious image. By this, the another part 13a becomes harmonious with the wall surface 1, thereby being less eye-catching, compared with the case the another part 13a becomes black. Especially, in case the display section 13b displays an ornamental image while the display section 13a displays a harmonious image, the television receiver 11 can serve as an aesthetic interior.

The example illustrated in (a) of FIG. 1, the part 13b displays the TV image or the ornamental image, and the another part 13a displays the harmonious image. Thus, the harmonious image display mode and one of the TV image display mode and the ornamental image display mode are selected at the same time in this example.

Moreover, as another example of the display mode of the television receiver 11, the display section 13 may have a plurality of parts 13b for displaying the TV image or the ornamental image of a certain fine art, and another region 13a for surrounding the plurality of parts 13b, as illustrated in (b) of FIG. 1. In this example, again, the another part 13a displays the image of the wall surface 1 as the harmonious image. By this, the another part 13a becomes harmonious with the wall surface 1, thereby being less eye-catching, compared with the case the another part 13a becomes black. Especially, in case the display sections 13b display an ornamental image while the display section 13a displays a harmonious image, the television receiver 11 can serve as an aesthetic interior.

Note that the parts 13b may be three or more, even though (b) of FIG. 1 exemplifies a case where there are two parts 13b.

Moreover, as one example of the harmonious image display mode, as illustrated in (c) of FIG. 1, the entire display section 13 displays the image of the wall surface 1 as the harmonious image. By this, the display section 13 becomes harmonious with the wall surface 1, thereby being less eye-catching, compared with the case the display section 13 turns off.

In still another example of the harmonious image display mode, as illustrated in (d) of FIG. 1, the television receiver 11 is installed on a wall surface 1′ with a pattern. The entire display section 13 displays an image of the wall surface 1′ as the harmonious image. In this case, the harmonious image may be an image similarly hued with (or of the same color as) the wall surface 1′ without pattern. However, the harmonious image identical with the image of the wall surface 1′ in terms of the polka dot pattern as well can be less eye-catching.

In any of the examples illustrated in FIGS. 1(a) to 1(d), it is not-limitedly preferable that the region (such as the another part 13a) of the display section 13 in which the harmonious image is displayed has a surface brightness of 50 cd/m² or less. When the harmonious image has a surface brightness of 50 cd/m² or less, the viewer recognizes the harmonious image as if the viewer looks reflection light. Thus, the harmonious image can be more blended into the wall surface 1 or 1′. The surface brightness may be changed in accordance with outside light of surrounding environment in which the television receiver 11 is installed (for example, the surface brightness may be changed in accordance with outside light brightness). More specifically, for example, when the outside light brightness of the surrounding environment is as dark as 100 cd/m² or less, it is preferable that the surface brightness of the harmonious image is 30 cd/m² or less.

Similarly, in case where part (such as part 13b) of the displays section 13 displays an ornamental image, it is not-limitedly preferable that the region (such as the another part 13a) of the display section 13 in which the harmonious image is displayed has a surface brightness of 50 cd/m² or less. By this, the television receiver 11 can be used an aesthetic interior for decoration when the display section 13 does not display a TV image.

That is, there is a case where brightness of the backlight is adjusted to be low in order to display the harmonious image or the ornamental image on the display section 13 of the television receiver 11. In this case, the harmonious image or the ornamental image can be recognized as an image (display image) but not as decorative article etc. as long as the adjusted brightness is within an image-display brightness range. This is because the viewer is watching luminescent light from the display section 13 when the viewer is watching the moving image of TV broadcast etc. on the television receiver 11, whereas the viewer is watching reflection light from a real fine art, photograph, wall surface etc. when the viewer is watching these real articles. In view of this, by arranging such that the display section 13 has a surface brightness of 50 cd/m² or less as described above, the viewer recognizes the image of the fine art, photograph, wall surface, etc. as if the viewer is watching reflection light thereof. Thus, the image of the fine art etc. can be displayed with more realistic look.

In order to grasp the surrounding environment in which the television receiver 11 is installed, the television receiver 11 may be provided with a sensor means such as photo sensor, CCD image sensor, or the like. For example, the outside light data (such as color, brightness, etc.) of illumination etc. in the surrounding environment may be obtained by use of the sensor means, and the control section 16 illustrated in FIG. 2 controls the display section 13 to change the surface brightness and color tone of the display according to the surrounding environment.

In the configuration of FIG. 2, the image capturing means 15 may have a photometric sensor or the like that also serves as the above sensor means. It may be arranged such that in case where the surrounding environment is so dark that the viewer cannot practically see an article therein, the light of the display section 13 may be fully turned off so as not to display any image including the harmonious image.

The changing operation of the surface brightness and color tone (color temperature correction etc.) of the display in the display section 13 (liquid crystal display section) may be carried out by adopting any known method. For example, the changing operation may carried out by 1) light modulation by using the backlight unit 18 illustrated in FIG. 2; 2) changing the display gray scale (for example, changing from high gray scale display to low gray scale display, etc.); 3) combination of 1) and 2); or 4) the other method. These method can be realized by controlling the operations of the LCD driver circuit 17 and/or the backlight unit 18 via the control section 16 illustrated in FIG. 2. Among the methods 1) to 3), the method 1) is preferable because it can performs smooth and natural (that is, most appropriate) gray scale display with lower power consumption. Especially, in case the backlight unit has light sources capable of controlling RGB independently, it is possible to carry out the color temperature correction by the backlight unit only.

In case where the light source of the backlight unit 18 is LED (light emitting diode), it is possible to emit light at a lower brightness than a light source such as CCFL (cold-cathode fluorescent light), and thus, it is possible to realize smooth display even at low gray scales. Further, in this case, color reproduction range is wide. Thus, the use of LED as the light source is preferable because it is possible to display the ornamental image or the harmonious image with colors more similar to object colors (that is, more naturally). Moreover, by causing in-plane change in the lighting of the LED as the light source according the display image, it is possible to attain lower power consumption together with greater display contrast.

Moreover, it may be arranged such that, in case where the ornamental image is displayed on the part (such as part 13b) of the display section 13, the ornamental image is displayed with an image of frame (picture-frame) externally surrounding the ornamental image. By this, it is possible to display the ornamental image on the display section 13 more naturally.

The present invention is not limited to the description exemplified above in which the television receiver 11 includes the image capturing means 15 for obtaining the harmonious image, and the storing means (image signal supplying section 14c) for storing therein the data of the harmonious image obtained by the image capturing means 15. For example, the television receiver 11 may be arranged such that the storing means stores a plurality of harmonious images and selects an appropriate harmonious image from the plurality of harmonious images according to the actual surrounding environment grasped from the background image obtained by the image capturing means 15. That is, in the present invention, the phrase “displaying the harmonious image according to the background image obtained by the image capturing means” encompasses an embodiment in which a harmonious image suitable for the background is selected according to color data etc. extracted from the background image obtained by the image capturing means.

The image capturing means 15 may be connected with the television receiver 11 by wireless or wired communication, or the like, always or sometimes when necessary to be connected. The location of the image capturing means 15 is not particularly limited. For example, the image capturing means 15 may be provided to a main body of the television receiver 11 or to a remote controller of the television receiver 11.

In the above description, a case where a still image is generally preferable as the ornamental image is exemplified. However, for example, the ornamental image may be a moving image having aesthetic interior property such as a moving image of a repeating motion pattern, the moving image being stored in a memory of the television receiver 11.

The present invention is not particularly limited to the above description in which the image display device includes the LCD panel. For example, the image display device may include an organic EL (Electro Luminescence) panel, or the like.

The present invention is not particularly limited to the above description in which the television receiver 11 is a thin wall-hung television receiver as a preferable example of the image display device. Moreover, the present invention is not particularly limited to the above description in which the television receiver 11 in which the tuner section is built in the main body of the television receiver 11 is exemplified. The tuner section may be provide to a device other than the main body of the television receiver 11.

The switchover of the display mode of the television receiver 11 may be carried out by the controller 16 in response to input (request) from the viewer. Moreover, it may be arranged such that a line-of-sight monitoring camera is provided so that the controller 16 receives information on whether or not the viewer is watching the television receiver 11, and the control section 16 controls the display mode automatically based on the information. For example, it may be so arranged that in case the control section 16 receives such information that the viewer is not watching the television receiver 11, the harmonious image is automatically displayed.

(Example of Flow of Display Operation of Harmonious Image)

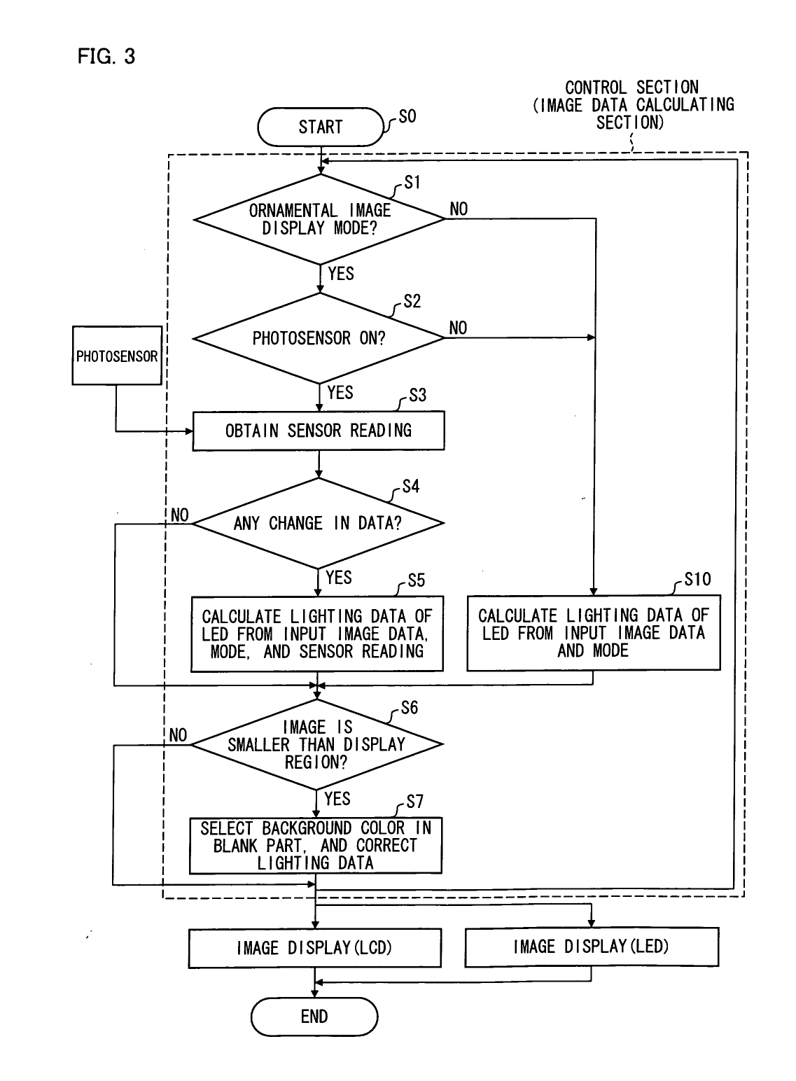

Next, one example of a flow of the display operation of a harmonious image (here, a non-patterned image identical with the wall as the background in terms of color) is described, referring to FIG. 3. Note that FIG. 3 is merely an example of the flow and the present invention is not limited to this example.

In this flow, at step 0 (hereinafter, “step” is abbreviated as S), the viewer of the television receiver 11 selects an image display mode. Next at step 1, the control section 16 determines whether the television receiver 11 is in the ornamental image display mode. Here, if the television receiver 11 is not in the ornamental image display mode, lighting data of the LED (light source) of the backlight unit 18 is calculated out based on the information of the input image signal and the information of the display mode (for example, information on whether the image display mode is the TV image display mode or the ornamental image display mode) at S10. Next, the process goes to S6. Then, the process goes to S7 in a certain case. Then, the LCD panel 19 and the backlight unit 18 are driven according to the information of the input image signal. Then, in case of the TV image display mode, an TV image is displayed on the display section 13, and in case of the ornamental image display mode, the harmonious image of the same color as the wall is displayed on the display section 13.

On the other hand, if the television receiver 11 is in the ornamental image display mode at S1, the process goes to S2. At S2, the control section 16 determines whether the photosensor (sensor means) is turned On or Off. If the photosensor is Off, the process goes to S10, and then, the LCD panel 19 and the backlight unit 18 are driven according to the information of the input image signal (for a fine art as the ornamental image in this case). In this way, the fine art is displayed on the entire display section 13.

On the other hand, if the photo sensor is On at S2, the process goes to S3. At S3, the control section 16 reads a sensor reading (outside light data) of the photosensor.

Next, the process goes to S4. At S4, the control section 16 determines whether the sensor reading of the photosensor is within a certain range (for example whether or not the outside light brightness is 100 cd/m² or less). Based whether the sensor reading is in or out of the certain range, the control section 16 determines whether to change the display. If the control section 16 determines to change the display in response to the sensor reading, the process goes to S5. At S5, the lighting data of the LED (light source) of the backlight unit 18 is calculated out based on the information of the input image signal and the information of the display mode (the image display mode is the ornamental image display mode), and the sensor reading. Then, the process goes to S6.

On the other hand, if the control section 16 determines not to change the display in response to the sensor reading at S4, the process goes to S6, but not to S5.

At S6, the control section 16 determines whether the image to be displayed (the ornamental image of the fine art in this case) is displayed on the entire display section 13, or on part of the display section 13. If the control section 13 determines to display the image on part of the display section 13, the process goes to S7.

At S7, a background color (corresponding to the harmonious image) for a blank part in which the ornamental image of the fine art is not displayed is selected, and the lighting data of the backlight unit 18 is modified according to the blank part.

Next, the LCD panel 19 and the backlight unit 18 are driven according to the input image signal, the display mode, and the sensor reading. In this way, the fine art is displayed on the part 13b of the display section 13, and the harmonious image of the same color as the wall is displayed on the blank part (the another part 13a) of the display section 13.

On the other hand, if it is determined at S6 that the image (here, for the fine art) is to be displayed on the entire display section 13, S7 is skipped and the LCD panel 19 and the backlight unit 18 are driven according to the input image signal, display mode, and the sensor reading, so as to display the fine art on the entire display section 13.

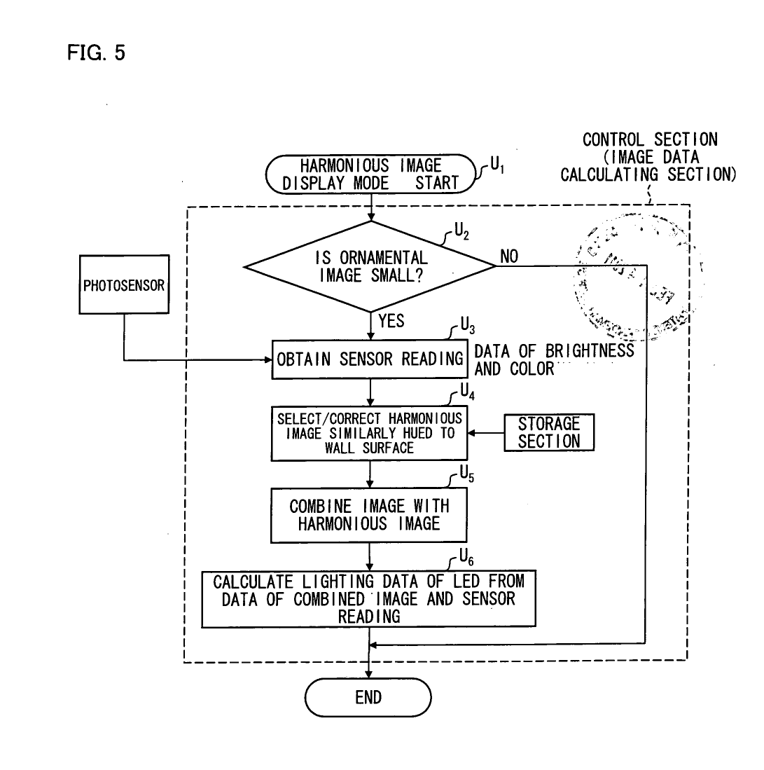

In the flow illustrated in FIG. 3, the harmonious image may be obtained by using a digital camera or the like (image capturing means) provided in addition to the photosensor. As an alternative, as described later referring to FIG. 5, it may be arranged such that the photosensor is configured to serve as the image capturing means, so that image data of the background is obtained by the photosensor and the harmonious image is displayed based on the image data of the background.

(Another Example of the Flow of the Display Operation of the Harmonious Image)

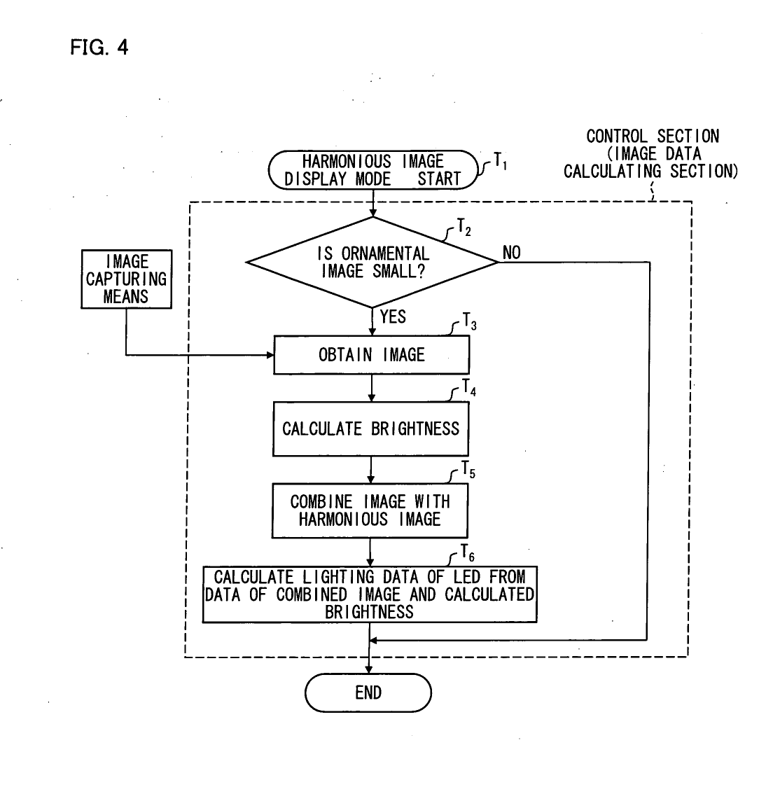

Referring to FIG. 4, the following describes another example of the flow of the display operation by the television receiver 11 for displaying the harmonious image (here, image of the wall surface as the background) and the ornamental image. Note that FIG. 4 merely illustrates one example of the flow, and the present invention is not limited to this flow.

In this flow, the viewer of the television receiver 11 selects the harmonious image display mode at step 1 (hereinafter, “step” is abbreviated as “T”)

At T2, the control section 16 determines whether the ornamental image to be displayed is displayed on the entire display section 13, or on part of the display section 13. If it is determined that the ornamental image is to be displayed on the entire display section 13 (i.e., in the case of “NO”), only the ornamental image is displayed on the display section 13.

On the other hand, if it is determined at T2 that the ornamental image is to be displayed on part of the display section 13, the process goes to T3.

At T3, the image capturing means 15 obtains the image of the wall, which is the background of the television receiver 11. Then, the image is supplied to the control section 16. The image supplied to the control section 16 is used as the harmonious image displayed on the blank part on which the ornamental image is to be displayed.

Next, at T4, the control section 16 calculates out the brightness of the display of the harmonious image on the display section 13 according to the image of the wall supplied to the control section 16 at T3.

Next, at T5, the control section 16 combines the harmonious image and the ornamental image both to be displayed on the display section 13. Then, the process goes to T6.

At T6, lighting data of the LED (light source) of the backlight unit 18 is calculated out based on the brightness calculated at T4 and data of the combined image prepared at T5. Next, the LCD panel 19 and the backlight unit 18 are driven according to the input image signal and the display mode, so as to display the fine art one the part 13b of the display section 13, and the image of the wall (i.e., the harmonious image) on the blank part (the another part 13a) of the display section 13.

(Still Another Example of the Flow of the Display Operation of the Harmonious Image)

Referring to FIG. 5, the following describes still another example of the flow of the display operation by the television receiver 11 for displaying the harmonious image (here, an image hued similarly to the wall surface as the background) and the ornamental image. Note that FIG. 5 illustrates merely an example of the flow, and the present invention is not limited to the example.

In this flow, unlike the one illustrated in FIG. 4, a most appropriate harmonious image (an image similarly hued to the background, more preferably an image of the same color as the background) is selected from among harmonious images stored in storing means (memory: storing section), and the display section 13 displays the most appropriate harmonious image.

In this flow, at step 1 (hereinafter, the “step” is abbreviated as U), the viewer of the television receiver 11 selects the harmonious image display mode.

At U2, the control section 16 determines whether the ornamental image to be displayed is to be displayed on the entire display section 13 or the part of the display section 13. If it is determined that the ornamental image displayed on the entire display section 13 (in the case of “NO”), the display section 13 displays only the ornamental image.

On the other hand, if it is determined at U2 that the ornamental image is to be displayed on part of the display section 13, the process goes to U3.

At US3, the control section 16 causes the photosensor (image capturing means), capable of obtaining color data and brightness data of the wall surface as the background, to supply the control section 16 the data obtained by the photosensor.

Next, at U4, according to the color data and the brightness data of the wall surface, the control section 16 selects a most appropriate harmonious image from among the plurality of harmonious images stored in the storing means. Here, the most appropriate harmonious image is an image similarly hued to the wall surface against which the television receiver 11 is installed. More preferably, the most appropriate harmonious image is an image of the same color as the wall surface.

Then, at U5, the control section 16 combines the harmonious image and the ornamental image both to be displayed on the display section 13. Then, the process goes to U6.

At U6, lighting data of the LED (light source) of the backlight unit 18 is calculated out based on data of the combined image prepared at U5 and the sensor reading. Next, the LCD panel 19 and the backlight unit 18 are driven according to the input image signal and the display mode, so as to display the fine art one the part 13b of the display section 13, and the image similarly hued to the wall (i.e., the harmonious image) on the blank part (the another part 13a) of the display section 13.

It may be arranged such that the storing means stores the harmonious image in association with color data of the harmonious image, so that the selection of the most appropriate harmonious image at U4 can be carried out referring to the color data. As an alternative, it may be arranged such that the storing means does not stores the color data of the harmonious image therein and the color data of the harmonious image is obtained for U4 by analyzing the harmonious image stored in the storing means.

Moreover, it may be so arranged that, if a harmonious image similarly hued to the background is not stored in the storing means at U4, a harmonious image is modified in color to be prepare a harmonious image similarly hued to the background.

(Another Modification)

In the above, a configuration in which the image display device displays the TV image as a moving image is exemplified. However, it may be arranged such that the image display device displays an other moving image such as a video image or DVD (digital Versatile Disc) image, in addition to or instead of the TV image.

Here, the image data of the harmonious image is stored in the storing means (corresponding to the image signal supplying section 14c in FIG. 2) provided to the image display device. It may be arranged such that the same harmonious image is displayed automatically unless setting of the image display device is changed.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The image display device and a method for driving the same according to the present invention are applicable to, for example, a wall-hung thin television receiver and the like.

### REFERENCE SIGNS LIST

1, 1′ Wall Surface (Background)
11 Television Receiver (Image Display Device)
13 Display Section
13a Another Part (Unused Portion of Display Section)
15 Image Capturing Means

1. An image display device comprising:
a display section for displaying an image;
image capturing means for obtaining a background image of a background against which the image display device is provided;
the display section displaying a harmonious image according to the background image obtained by the image capturing means, the harmonious image being in harmony with the background.

2. An image display device as set forth in claim 1, wherein the harmonious image is hued similarly to the background.

3. An image display device as set forth in claim 1, wherein the harmonious image is the background image.

4. An image display device as set forth in claim 1, wherein the image capturing means is a digital camera or a photosensor.

5. An image display device as set forth in claim 1, wherein:
the image display device is a television receiver; and
the display section displays the harmonious image when the display section does not display a television image.

6. An image display device as set forth in claim 1, wherein:
the display section displays an image smaller than a size of the display section, and displays the harmonious image in a region in which the image is not displayed.

7. An image display device as set forth in claim 1, wherein the region in which the harmonious image is displayed has a surface brightness of 50 cd/m² or less.

8. A method of driving an image display device having a display section for displaying an image, the method comprising:
obtaining a background image of a background against which the image display device is provided; and
the display section displaying a harmonious image according to the background image thus obtained, the harmonious image being in harmony with the background.

9. A method as set forth in claim 8, wherein:
the image display device is a television receiver; and
the display section displays the harmonious image when the display section does not display a television image.

10. A method as set forth in claim 8, wherein:
the display section displays an image smaller than a size of the display section, and displays the harmonious image in a region in which the image is not displayed.
